(19) United States
(12) Patent Application Publication
(10) Pub. No.: US 2008/0027766 A1
(43) Pub. Date: Jan. 31, 2008

(54) Methods and Systems for Determining Availability of a Resource for Particular Time Periods

(76) Inventors: K. Bradford Carr, Hingham, MA (US); Israel Del Rio, White Plains, NY (US); Chuck Heuer, Chester, NH (US); Tom Toppel, Larkspur, CO (US)

Correspondence Address: BAKER BOTTS L.L.P., 30 ROCKEFELLER PLAZA, 44TH FLOOR, NEW YORK, NY, 10112-4498, US

(21) Appl. No.: 11/615,594

(22) Filed: Dec. 22, 2006

Related U.S. Application Data
(60) Provisional application No. 60/753,455, filed on Dec. 22, 2005.

(51) Int. Cl. G06Q 10/00

(52) U.S. Cl. 705/5

(57) ABSTRACT

Checking the availability of a rental resource by providing a commitment memory area configured to store at least one resource data element corresponding to a rental resource, the at least one resource data element configured to store at least one commitment period made up of at least a start time and an end time, receiving a commitment request including a first start time and a first end time, and returning a positive availability response when the first start time and the first end time are not stored in any of the at least one commitment periods in any of the at least one resource data elements. In further embodiments, a positive availability response is returned when the time period defined by the first start time and the first end time does not intersect with at least one commitment period in each of the resource data elements in the commitment memory area. In another embodiment, the commitment request includes data corresponding to a desired rental resource and only the resource data elements corresponding to that rental resource should be considered for intersections when determining availability. In further embodiments, a resource data element can contain at least one attribute. In other embodiments, a commitment request can contain data corresponding to one or more specific attributes, and only those resource data elements with those elements will be considered for availability. In further embodiments, the resource is a hotel room.

### RELATED APPLICATIONS

This application claims priority to U.S. provisional application 60/753,455, filed on Dec. 22, 2005, and entitled “Techniques for Determining Availability of a Resource for Particular Time Periods,” which is hereby incorporated by reference in its entirety.

### BACKGROUND

Storing data concerning the availability of a rental resource has typically involved the use of a calendar (or bucket) model whereby data about the total number of resources available is stored for each of a set of pre-determined time units, such as days or nights. This system requires that data be allocated for every individual time unit, regardless of whether a rental resource has been committed for that time period or not. This system results not only in a lack of flexibility but a data-storage limit on how far in advance a reservation can be made.

With regard to the lack of flexibility, when a reservation system utilizes this calendar model, one must pre-define the time units by which rental resources can be reserved. In the hotel industry this is typically by night or day, but any time unit is possible. However, if a rental resource is reserved by the night, then the system does not facilitate renting a resource during the day for one purpose and at night for another. Further, it is possible that a rental resource could be needed for only a fraction of the pre-defined time unit, but the calendar model would not allow the un-used time to be committed to another purpose. While simply dividing the time unit into smaller fractions may be possible, such a solution leads to the next problem, a data-storage limit on the number of time units that can be economically stored.

Because data must be stored for each rental resource, or group of rental resources, and for each time period, regardless of whether that resource has been committed or not, a great amount of data is used. For instance, if a hotel has 1000 rentable resources, and the availability of each resource is tracked using the bucket system, then a record would have to be kept for every time unit for which the resource could be rented. This presents a natural “horizon” to how far in advance a commitment can be made. A hotel wishing to store availability data about 1000 rentable resources for a year would require at least 1000*365=365,000 records. The number of records required expands as the number of resources increases or the horizon is pushed into the future. Moreover, it is possible that many of the records would never be accessed, and the system remains incapable of making commitments for a time period beyond the predetermined horizon.

### SUMMARY

Methods and systems for determining the availability of a resource for particular time periods are disclosed herein.

In some embodiments, methods for adding a rental resource commitment to a commitment tracking system include providing a commitment memory area configured to store at least one resource data element corresponding to a rental resource, where the at least one resource data element is configured to store at least one commitment period including at least a start time and an end time, receiving a commitment request including a first start time and a first end time, and storing in the at least one resource data element a first commitment period made up of at least the first start time and the first end time. In other embodiments, the commitment request also contains data corresponding to a desired rental resource and the first commitment period made up of at least the first start time and the first end time are stored in the resource data element corresponding to that desired rental resource. In other embodiments, the resource is a hotel room.

In some embodiments, methods for removing a rental resource commitment from a commitment tracking system include providing a commitment memory area configured to store at least one resource data element corresponding to a rental resource, wherein the at least one resource data element is configured to store at least one commitment period made up of at least a start time and an end time, receiving a commitment removal request including a first start time and a first end time, and removing the at least one commitment period from the at least one resource data element if the at least one commitment period stores the first start time and the first end time. In other embodiments, the commitment removal request also contains data corresponding to a desired rental resource and a commitment period made up of at least the first start time and the first end time is removed only from a resource data element corresponding to the desired rental resource. In other embodiments, the resource is a hotel room.

In some embodiments, methods for checking the availability of a rental resource include providing a commitment memory area configured to store at least one resource data element corresponding to a rental resource, the at least one resource data element configured to store at least one commitment period made up of at least a start time and an end time, receiving a commitment request including a first start time and a first end time, and returning a positive availability response when the first start time and the first end time are not stored in any of the at least one commitment periods in any of the at least one resource data elements. In further embodiments, a positive availability response is returned when the time period defined by the first start time and the first end time does not intersect with at least one commitment period in each of the resource data elements in the commitment memory area. In another embodiment, the commitment request includes data corresponding to a desired rental resource and only the resource data elements corresponding to that rental resource should be considered for intersections when determining availability. In further embodiments, a resource data element can contain at least one attribute. In other embodiments, a commitment request can contain data corresponding to one or more specific attributes, and only those resource data elements with those elements will be considered for availability. In further embodiments, the resource is a hotel room.

In some embodiments, systems for adding a commitment, removing a commitment or checking the availability of a resource include computer readable media having a set of instructions operable to direct a processor to perform the steps of the above embodiments.

### BRIEF DESCRIPTION OF THE DRAWINGS

Further objects, features and advantages of the disclosed subject matter will become apparent from the following detailed description taken in conjunction with the accompanying figures showing an embodiment of the invention of which:

FIG. 1 is a diagram of adding a commitment for a resource.

FIG. 2 is a diagram of the commitment memory area.

FIG. 3 is a diagram of removing a commitment for a resource.

FIG. 4 is a diagram of checking the availability of a resource.

FIG. 5 is a diagram of a data structure for the tracking of resource availability.

### DETAILED DESCRIPTION

The disclosed subject matter is directed to methods and systems for determining the availability of a resource for particular time periods. By providing for the storage of commitment data when that commitment is made, and then checking availability based on whether no commitment exists for a specific time period, the disclosed subject matter addresses both the lack of flexibility and the temporal horizon on how far in advance a commitment can be made. To address the lack of flexibility, the disclosed subject matter allows a commitment to be defined by a start and end time, or start time and duration. The start and end times can be stored by the day, hour, minute, second, or any other time unit that is desired. This allows, for instance, a hotel room that before was only rentable per night, to be rented for two hours in the morning by a first renter, a half hour in the afternoon by a second renter and the entire night by a third renter. Moreover, with the ability to store only the commitments when they are made, data usage can be reduced and a commitment can be recorded for a time period that before would have exceeded the temporal horizon.

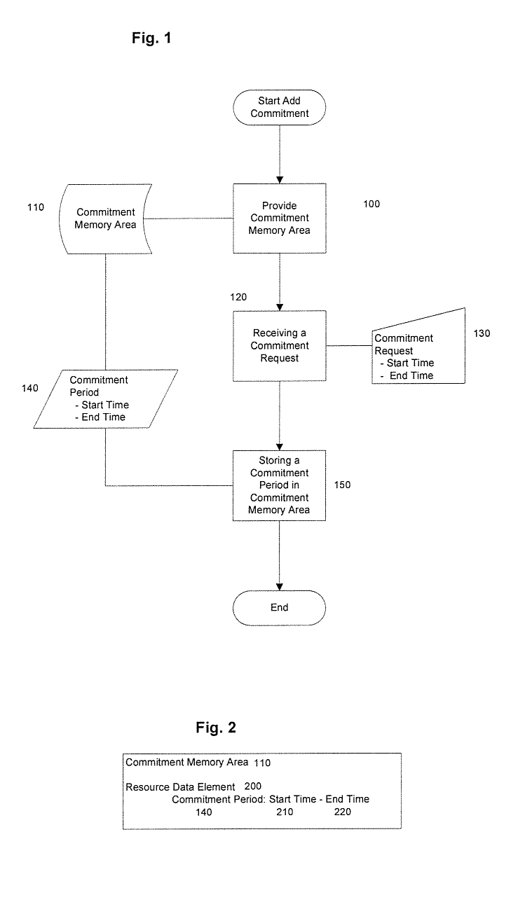

FIG. 1 represents an embodiment of adding a commitment. A commitment memory area 110 is provided 100. The commitment memory area 110 can be stored in a database, on a hard drive, in a main frame, in a flash memory medium, on a diskette, or in any other computer-readable memory unit. The commitment memory area 110, as seen in FIG. 2, can comprise at least one resource data element 200. Each resource data element 200 can correspond to one or more resources and can contain a commitment period 140 which has a corresponding start time 210 and end time 220. Each commitment period represents a rental period, between the start time 210 and end time 220 stored in that particular commitment period 140, during which the rental resource associated with a particular rental resource data element 200 is committed, or not available. A resource or rental resource can be a conference room, recreational equipment, a vehicle, a service provider, such as a trainer, hair stylist, doctor, dentist, or any other resource that can be allocated based on time.

A commitment request 130, which includes at least a start time and an end time, is received 120 and the start time and end time of the commitment request 130 can be stored 150 in a commitment period 140 that is added to at least one resource data element 200 in the commitment memory area 110. The commitment request 130 can come from a user or system capable of requesting a rental resource and represents a time period for which a resource is needed. Storing the start time and end time of the commitment request 130 in a resource data element 200 signifies that the resource corresponding to that resource data element is occupied or committed for the period between that first time and end time. In another embodiment, the commitment request 130 further includes data referencing one or more desired rental resources. The start time and end time of that commitment request can be stored 150 in a commitment period 140 that is then stored in the resource data element 200 corresponding to the one or more desired rental resources.

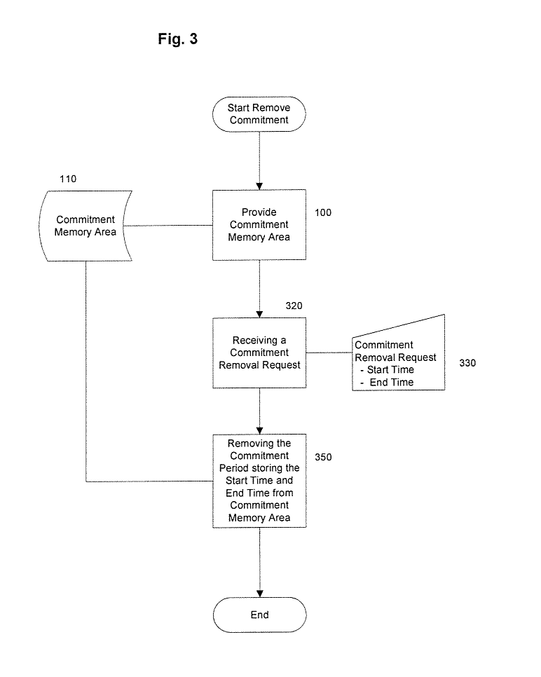

FIG. 3 represents an embodiment of removing a commitment. A commitment memory area 110 is provided 100. The commitment memory area can be stored in a database, on a hard drive, in a main frame, in a flash memory medium, on a diskette, or in any other computer-readable memory unit. The commitment memory area 110, as seen in FIG. 2, can comprise at least one resource data element 200. Each resource data element 200 can correspond to one or more resources and can contain a commitment period 140 which has a corresponding start time 210 and end time 220.

A commitment removal request 330, including a start time and an end time is received 320 and at least one commitment period 140 which stores the start time and end time of the commitment removal request 330 can be removed 350 from a resource data element 200 stored in the commitment memory area 110. The commitment removal request 330 can come from a user or system capable of requesting the removal of a rental resource commitment and represents a time period for which a resource is no longer needed. In a further embodiment, the commitment removal request 330 also includes data referencing one or more specific rental resources. A commitment period 140 storing the start time and end time from the commitment removal request 330 can be removed 350 from those resource data elements 200 corresponding to the one or more specific rental resources referenced by the data in the commitment removal request 330.

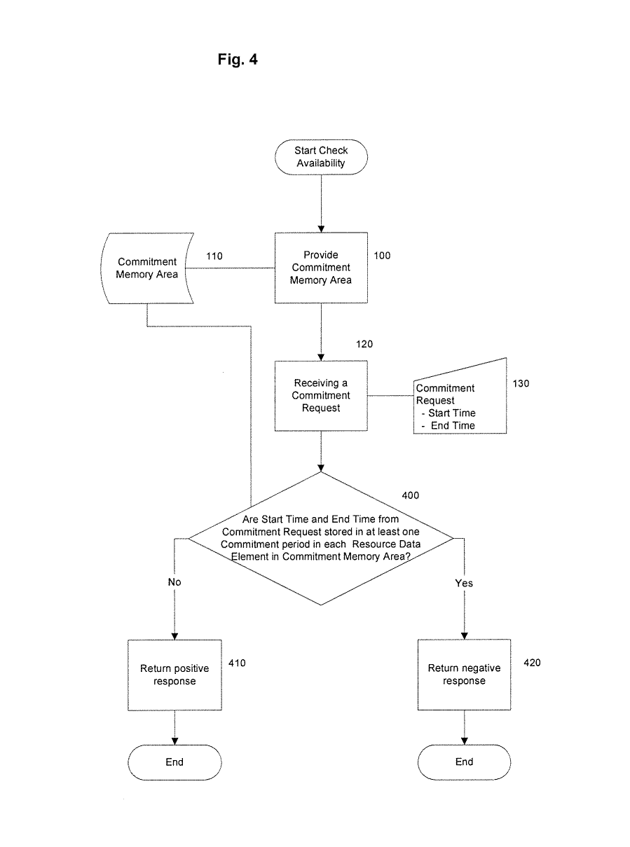

FIG. 4 represents an embodiment of checking the availability of a rental resource. A commitment memory area 110 is provided 100 as in previous embodiments. The commitment memory area can be stored in a database, on a hard drive, in a main frame, in a flash memory medium, on a diskette, or in any other computer-readable memory unit. The commitment memory area 110, as seen in FIG. 2, can comprise at least one resource data element 200. Each resource data element 200 can correspond to one or more resources and can contain a commitment period 140 which has a corresponding start time 210 and end time 220.

In the embodiment shown in FIG. 4, a commitment request 130 is received 120 which contains a start time and an end time. The commitment request 130 can come from a user or system capable of requesting a rental resource and represents a time period for which a resource is needed. To check whether a resource is available for the commitment period defined by the start time and end time of the commitment request 130, each resource data element 200 is considered 400. If any resource data element 200 does not contain a commitment period 140 with a start time 210 and end time 220 matching those of the commitment request 130, then a resource is available and a positive response is returned 410. Otherwise, the resource is not available and a negative response is returned 420.

In further embodiments, the commitment request 130 further includes data referencing one or more desired rental resources and only the resource data elements 200 corresponding to the one or more desired rental resources are considered to determine availability.

In other embodiments of checking the availability of a rental resource, the determining step 400 considers whether an intersection exists between the commitment periods 140 stored in the commitment memory area 110 and the period between the start time and end time of the commitment request 130. As such, a negative availability response can be returned 420 when each resource data element 200 contains at least one commitment period 140 that intersects with the period between the start time and end time of the commitment request 130. Otherwise, a positive availability response can be returned 420. In other terms, in this embodiment, if any resource data element 200 stored in the commitment memory area 110 has no commitment period 140 that intersects with the period defined by the start time and end time of the commitment request 130, then the resource, or resources, corresponding to that resource data element 200 is available.

In another embodiment, each resource data element 200 can also store at least one attribute. An attribute can be a characteristic about the resource. In an embodiment where the resource is a hotel room, an attribute could be the bed size, room size, view from a window, smoking designation or any other characteristic about the room that may need to be recorded. In an embodiment where the resource is the time of a service provider, an attribute could be the educational background of the service provider, the area of specialty, the gender of the service provider, their years of experience or any other characteristic about the service provider that may need to be recorded. In some embodiments, multiple attributes are stored in each resource data element. In some embodiments, a commitment request 130 can include data associated with one or more specific attributes and only those resource data elements 200 containing those specific attributes are considered to determine availability.

In some embodiments, resources can correspond to actual physical objects, such as a hotel room, a vehicle, or a conference room. In other embodiments, resources can correspond to the time of a service provider such as a trainer, hair stylist, lawyer, doctor, or dentist. In yet other embodiments, resources can be grouped together and one resource may reference other resources. For instance, in one embodiment a first resource can correspond to a massage and that first resource can reference a massage therapist resource, a massage facility room resource, and a technician resource to set-up and breakdown the massage facility room. In this way, a single massage resource actually references three different resources.

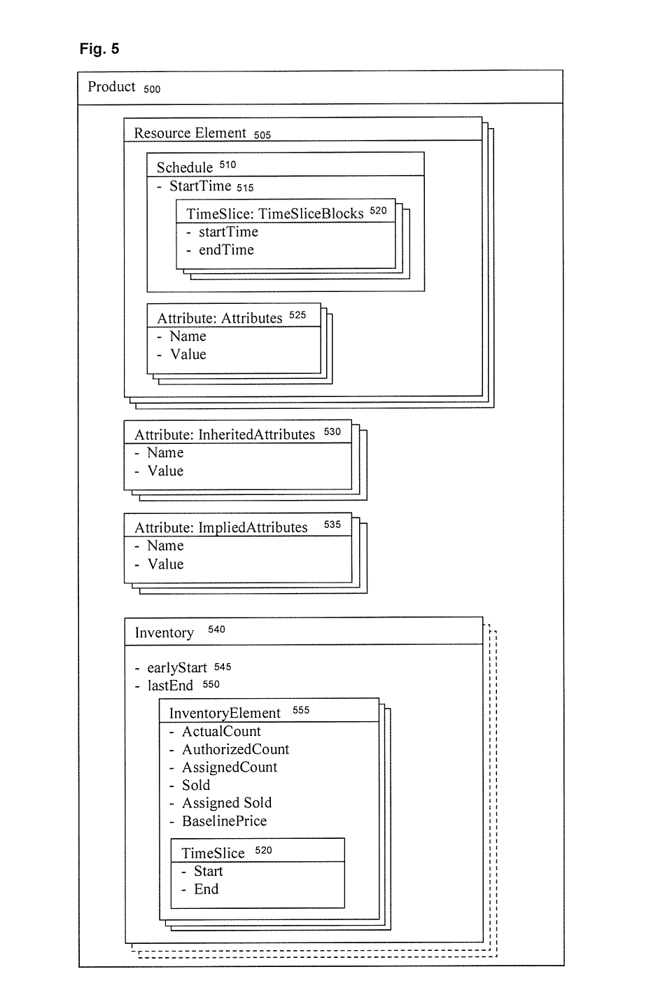

In another embodiment, as seen in FIG. 5, a data structure to track availability is organized into products 500. Each product can represent what is actually sold to a customer. While a product is not necessarily tangible, it can reference or contain specific resources that are the tangible products or services that are sold or rented. In some embodiments a product can allow the seller or renter of the resource to add descriptive information about a product and its referenced or contained resources such as sales information, terms and conditions, time frames for rental as well as pricing and other financial data. In one example of an embodiment of a product in the hotel industry context, a hotel may have 100 rooms. Each of those rooms may have a resource associated with it. In the sales process, the resources can be offered for sale through a plurality of products, which can be more or less than the number of resources. In this particular embodiment, the products can be room types such as king non-smoking, two bed non-smoking, view room, suite, etc. In some embodiments, the number of each particular product available may be stored in the product data structure as well.

In some embodiments a product, such as a hotel room may have many resources elements associated with it such as the room itself, the staff to service the room, and other facilities and services attendant to that room. Each product can maintain a dynamic collection of resource elements 505. A dynamic collection can be an array, a vector, or any other dynamic data structure capable of holding a non-defined number of objects. In other embodiments, multiple products may reference or contain the same resource. For example, a suite product may contain or reference two connected rooms, however each of those connected rooms can also be contained or referenced by a different product representing two bed rooms or king bed rooms. In this way, in some embodiments a product can reference or contain multiple resources, and resources can be referenced or contained by multiple products.

Each resource element, in this embodiment, can have a schedule 510. The schedule maintains a start time value 515 which represents the earliest time that the resource element can be committed, and a dynamic collection of time slices 520. Each time slice contains a start time and an end time and two time slices can be added together. For every time in the schedule that no time slice exists, the resource element is available, otherwise that resource element is committed. The resource elements can also maintain a dynamic collection of attributes 525, each attribute maintaining at least a name and a value. An attribute is a descriptive element and can be binary, where the attribute is either true or not true, structured, where the attribute must be selected from a pre-defined set of possibilities, or unstructured, wherein the attribute could be any value desired.

A product, in some embodiments, can further have a dynamic collection of inherited attributes 530, or attributes that are common to all resource elements in the product. A product may also have a dynamic collection of implied attributes 535, or attributes that are not contained in all resource elements stored in the product but which may be in some resource elements.

A product can also maintain an inventory 540. Each inventory can hold a dynamic collection of inventory elements 555. Each inventory element can hold the sales information for a specific allowable time slice 520. In one embodiment, each inventory element can hold information about the same time slice for a series of days or other time units such as hours weeks, months, etc. Inventory elements can also maintain a count of products represented by the inventory, a count of the number of products that are authorized to be sold, a count of products that are assigned to be sold, a count of the number of products actually sold, and a count of the assigned products that were sold for the associated time slice. The count of products that are authorized to be sold can be used to take into account either out of order resources or the practice of over-booking a product, or committing a product for more resource elements than are actually available. Additionally, each inventory element can hold a baseline price which is an element with a dynamic collection of prices in various currencies. Additionally, each inventory can maintain an early start time 545 and an early end time 550 which represents the earliest and latest times that the product can be scheduled for, taking into consideration any set-up or breakdown times. For instance, while a hotel room resource may be available from 11:00 AM on one day to 9:00 AM on the next day, hotel services may need to clean or alter the hotel room such that the hotel room is not actually available from exactly 11:00 AM to 9:00 AM.

In some embodiments, the disclosed subject matter can be used by a spa. There the spa can use the resources and/or products model to reserve rooms as well as reserve and schedule the use of staff involved in the delivery of services. In other embodiments, the disclosed subject matter can be used on a golf course. Each tee on a golf course (likely the 1st through the 9th) can be defined as resources and/or products such that tee times can be sold in any number of time increments. In yet other embodiments, the disclosed subject matter can be used for a tennis court. The tennis courts can be described as resources and/or products and allow patrons to reserve them for specific time periods. Additionally, the time of a tennis instructor can be defined as a resource and/or product and scheduled with the tennis court.

We claim:

1. A method for adding a rental resource commitment to a commitment tracking system comprising:
providing a commitment memory area configured to store at least one resource data element corresponding to a rental resource, said at least one resource data element configured to store at least one commitment period comprising at least a start time and an end time;
receiving a commitment request comprising a first start time and a first end time; and
storing in said at least one resource data element a first commitment period comprising said first start time and said first end time.

2. The method of claim 1 wherein said commitment request further comprises data corresponding to a rental resource, and said storing step further comprises storing a first commitment period comprising said first start time and said first end time in a rental resource data element corresponding to said rental resource.

3. The method of claim 1 wherein said rental resource is a room at a hotel.

4. A method for removing a rental resource commitment from a commitment tracking system comprising:
providing a commitment memory area configured to store at least one resource data element corresponding to a rental resource, said at least one resource data element configured to store at least one commitment period comprising at least a start time and an end time;
receiving a commitment removal request comprising a first start time and a first end time; and
removing said at least one commitment period from said at least one resource data element if said at least one commitment period stores said first start time and said first end time.

5. The method of claim 4 wherein said commitment removal request further comprises data corresponding to a rental resource, and said removing step further comprises removing a commitment period comprising said first start time and said first end time from a resource data element corresponding to said rental resource.

6. The method of claim 4 wherein said rental resource is a room at a hotel.

7. A method for checking the availability of a rental resource comprising:
providing a commitment memory area configured to store at least one resource data element corresponding to a rental resource, said at least one resource data element configured to store at least one commitment period comprising at least a start time and an end time;
receiving a commitment request comprising a first start time and a first end time; and
returning a positive availability response when, for at least one of said at least one resource data elements, said first start time and said first end time are not stored in any of said at least one commitment periods.

8. The method of claim 7 wherein said rental resource comprises a hotel room.

9. The method of claim 7 wherein said returning comprises returning a positive availability response when, for at least one of said at least one resource data element, a first commitment period comprising said first start time and said first end time intersects with none of said at least one commitment periods.

10. The method of claim 7 wherein said commitment request further comprises data corresponding to a first rental resource, and said returning comprises returning a positive availability response when a first commitment period comprising said first start time and said first end time intersect with none of said at least one commitment periods stored in a resource data element corresponding with said first rental resource.

11. The method of claim 7 wherein said resource data element further comprises at least one attribute.

12. The method of claim 11 wherein said commitment request further comprises at least one attribute, and said returning comprises returning a positive availability response when a first commitment period comprising said first start time and said first end time intersect with none of said at least one commitment periods stored in any of said resource data elements comprising said at least one attribute.

13. The method of claim 7 wherein said rental resource is a room at a hotel.

14. A computer readable medium having a set of instructions operable to direct a processor to perform the steps of:
allocating a commitment memory area configured to store at least one resource data element corresponding to a rental resource, said at least one resource data element configured to store at least one commitment period comprising at least a start time and an end time;
receiving a commitment request comprising a first start time and a first end time; and
storing in said at least one resource data element a first commitment period comprising said first start time and said first end time.

15. The computer readable medium of claim 14 wherein said commitment request further comprises data corresponding to a rental resource, and said storing step further comprises storing a first commitment period comprising said first start time and said first end time in a rental resource data element corresponding to said rental resource.

16. The computer readable medium of claim 14 wherein said rental resource is a room at a hotel.

17. A computer readable medium having a set of instructions operable to direct a processor to perform the steps of:
allocating a commitment memory area configured to store at least one resource data element corresponding to a rental resource, said at least one resource data element configured to store at least one commitment period comprising at least a start time and an end time;
receiving a commitment removal request comprising a first start time and a first end time; and
removing said at least one commitment period from said at least one resource data element if said at least one commitment period stores said first start time and said first end time.

18. The computer readable medium of claim 17 wherein said commitment removal request further comprises data corresponding to a rental resource, and said removing step further comprises removing a commitment period comprising said first start time and said first end time from a resource data element corresponding to said rental resource.

19. The computer readable medium of claim 17 wherein said rental resource is a room at a hotel.

20. A computer readable medium having a set of instructions operable to direct a processor to perform the steps of:
allocating a commitment memory area configured to store at least one resource data element corresponding to a rental resource, said at least one resource data element configured to store at least one commitment period comprising at least a start time and an end time;
receiving a commitment request comprising a first start time and a first end time; and
returning a positive availability response when, for at least one of said at least one resource data elements, said first start time and said first end time are not stored in any of said at least one commitment periods.

21. The computer readable medium of claim 20 wherein said rental resource comprises a hotel room.

22. The computer readable medium of claim 20 wherein said returning comprises returning a positive availability response when, for at least one of said at least one resource data element, a first commitment period comprising said first start time and said first end time intersects with none of said at least one commitment periods.

23. The computer readable medium of claim 20 wherein said commitment request further comprises data corresponding to a first rental resource, and said returning comprises returning a positive availability response when a first commitment period comprising said first start time and said first end time intersect with none of said at least one commitment periods stored in a resource data element corresponding with said first rental resource.

24. The computer readable medium of claim 20 wherein said resource data element further comprises at least one attribute.

25. The computer readable medium of claim 24 wherein said commitment request further comprises at least one attribute, and said returning comprises returning a positive availability response when a first commitment period comprising said first start time and said first end time intersect with none of said at least one commitment periods stored in any of said resource data elements comprising said at least one attribute.

26. The computer readable medium of claim 20 wherein said rental resource is a room at a hotel.
